(19) United States
(12) Patent Application Publication
(10) Pub. No.: US 2026/0001255 A1
(43) Pub. Date: Jan. 1, 2026

(54) PREFORM MANUFACTURING DEVICE, MANUFACTURING METHOD, AND MOLD FOR COOLING

(71) Applicant: NISSEI ASB MACHINE CO., LTD., Nagano (JP)

(72) Inventors: Yukihiro ICHIHASHI, Nagano (JP); Daizaburo TAKEHANA, Nagano (JP)

(73) Assignee: NISSEI ASB MACHINE CO., LTD., Nagano (JP)

(21) Appl. No.: 19/105,471

(22) PCT Filed: Aug. 25, 2023
(86) PCT No.: PCT/JP2023/030694

§ 371 Date: Apr. 25, 2025

(30) Foreign Application Priority Data
Aug. 29, 2022 (JP) 2022-135656

(51) Int. Cl. B29B 13/04; B29B 11/08; B29C 49/64

(52) U.S. Cl. CPC B29B 13/04; B29B 11/08; B29C 49/643; B29C 49/6465

(57) ABSTRACT

A preform manufacturing apparatus includes an injection molding unit, a post-cooling unit, and a taking-out unit. The post-cooling unit includes a first mold which accommodates the preform inside and which contacts the outer surface of the preform; and a second mold which is inserted into the preform and which is provided with at least a cooling rod having an internal flow path for compressed air and a tip piece which is attached to a tip side of the cooling rod. The tip piece has a shape corresponding to a bottom of the preform and includes a mold surface that receives the bottom, and an opening formed on a base end side of the mold surface and communicating with the flow path of the compressed air. The post-cooling unit cools the bottom of the preform while pressing the bottom of the preform against the first mold with the mold surface of the tip piece, and cools a body portion of the preform while pressing the body portion against the first mold with the compressed air passing through the opening.

### BACKGROUND OF THE INVENTION

### Field of the Invention

The present invention relates to a preform manufacturing apparatus, a manufacturing method, and a cooling mold.

### Description of the Related Art

Conventionally, a rotary injection molding machine that uses vertical movement and circumferential movement of a transfer plate to sequentially transfer an injection-molded resin preform to a post-cooling unit and a taking-out unit is known (see, for example, Japanese Examined Publication No. H7-8516).

Further, in blow molding of a hot-parison resin container, it has been proposed to shorten a cooling time of a preform in an injection mold and shorten a molding cycle of the resin container (for example, see Japanese Patent No. 6505344).

Regarding the manufacturing of a preform, as in the case of blow molding of a resin container, it has been studied to shorten the cooling time of the preform in an injection mold from the viewpoint of shortening the manufacturing cycle.

On the other hand, when the cooling time of the preform in the injection mold is shortened, since the preform is released from the injection mold at a higher temperature than usual, the preform is easily shrunk and deformed. Consequently, dimensional accuracy of the preform is easily deteriorated and appearance defects (sink marks) are easily generated. Additionally, since the preform released at a high temperature as described above is very soft, for example, when air is blown to the bottom of the preform at the time of cooling, the bottom of the preform exposed to the air may be deformed by the air pressure, leading to decrease in dimensional accuracy.

### SUMMARY OF THE INVENTION

A preform manufacturing apparatus according to one aspect of the present invention includes an injection molding unit which injects and molds a bottomed cylindrical resin preform using an injection mold; a post-cooling unit which cools the preform manufactured in the injection molding unit; and a taking-out unit which takes-out the preform cooled in the post-cooling unit to the outside of the apparatus. The post-cooling unit includes a first mold which accommodates the preform inside and which contacts the outer surface of the preform; and a second mold which is inserted into the preform and which is provided with at least a cooling rod having an internal flow path for compressed air and a tip piece which is attached to a tip side of the cooling rod. The tip piece has a shape corresponding to a bottom of the preform and includes a mold surface that receives the bottom, and an opening formed on a base end side of the mold surface and communicating with the flow path of the compressed air. The post-cooling unit cools the bottom of the preform while pressing the bottom of the preform against the first mold with the mold surface of the tip piece, and cools a body portion of the preform while pressing the body portion against the first mold with the compressed air passing through the opening.

Further features of the present invention will become apparent from the following description of exemplary embodiments with reference to the attached drawings.

### BRIEF DESCRIPTION OF THE DRAWINGS

FIG. 1 is a diagram illustrating a configuration example of an injection molding apparatus according to the present embodiment.

FIG. 2 is a diagram illustrating a configuration example of a post-cooling unit in FIG. 1.

FIGS. 3A and 3B are perspective views illustrating a tip portion of a cooling rod in FIG. 2.

FIG. 4 is a diagram illustrating a configuration example of a taking-out unit in FIG. 1.

FIG. 5 is a flowchart illustrating steps of a preform manufacturing method.

### DESCRIPTION OF THE EMBODIMENTS

Hereinafter, the embodiment of the present invention will be described with reference to the drawings.

In the embodiment, for better understanding, structures and elements other than the main parts of the present invention will be described in a simplified or omitted manner. In the drawings, the same elements are denoted by the same reference numerals. Note that shapes and dimensions of the respective elements shown in the drawings are schematically illustrated, and do not indicate actual shapes and dimensions.

### Description of Injection Molding Apparatus

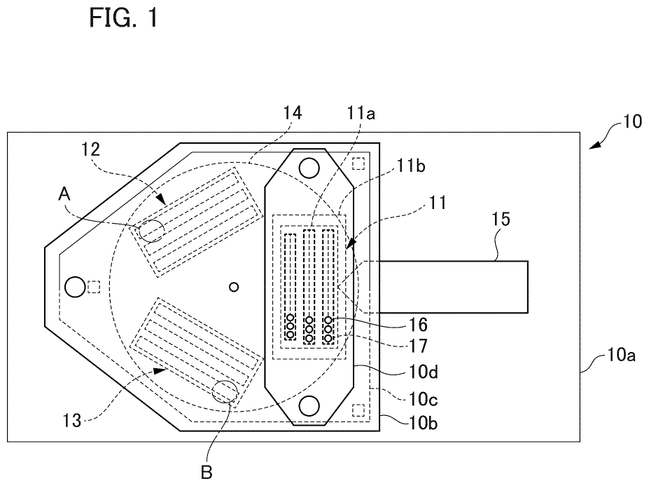

FIG. 1 is a diagram illustrating a configuration example of an injection molding apparatus 10 according to the present embodiment. The injection molding apparatus 10 of the present embodiment is a manufacturing apparatus used for manufacturing a resin preform 1 at high speed.

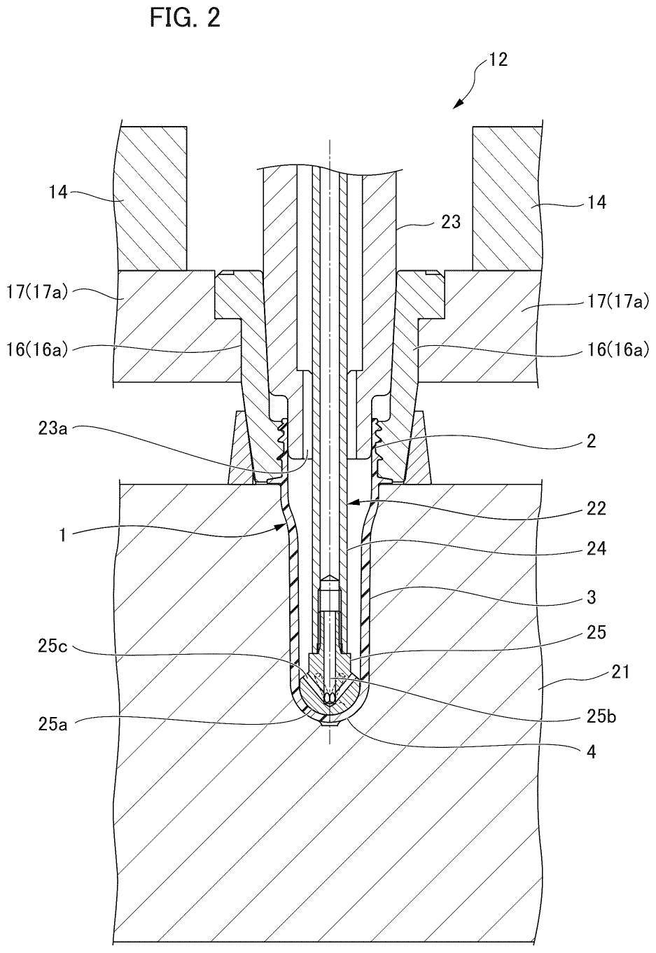

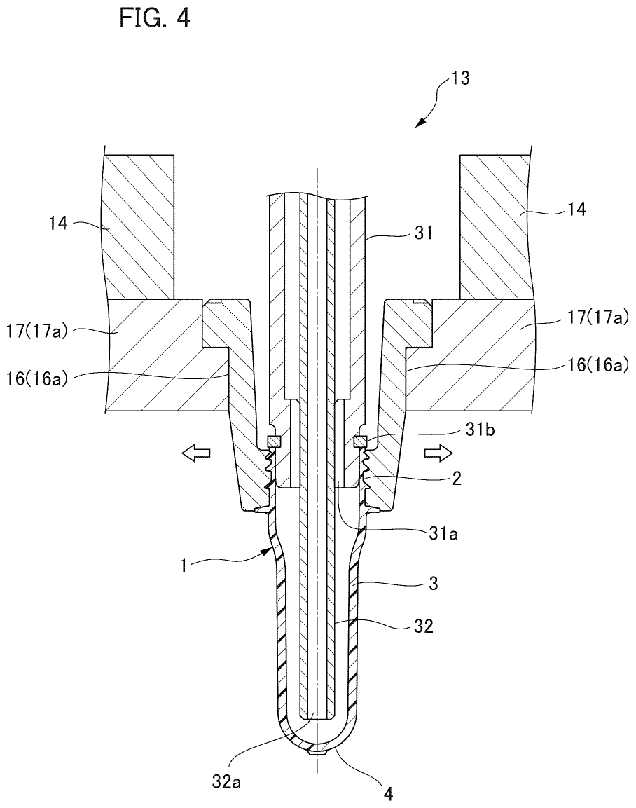

The entire shape of the preform 1 is a bottomed cylindrical shape in which one end side is open and the other end side is closed as illustrated in FIGS. 2 and 4 to be described later. The preform 1 includes a body portion 3 formed in a cylindrical shape, a bottom 4 that closes the other end side of the body portion 3, and a neck portion 2 formed on an opening side on one end side of the body portion 3.

The injection molding apparatus 10 includes an injection molding unit 11, a post-cooling unit 12, a taking-out unit 13, a transfer plate 14 as a conveyance mechanism, and an injection device 15. The injection molding apparatus 10 further includes a machine bed 10a, an upper base 10b, a lower base 10c, and an injection core mold movable platen 10d. On the upper side of the machine bed 10a, the lower base 10c and the injection device 15 are disposed.

The upper base 10b is erected above the lower base 10c via a guide rod, and is disposed so as to be vertically movable up and down with respect to the lower base 10c. The injection core mold movable platen 10d is erected above the upper base 10b via the guide rod, and is disposed so as to be movable up and down in the vertical direction with respect to the upper base 10b. The transfer plate 14 is rotatably supported by the lower surface of the upper base 10b.

Note that, above the upper base 10b, at a position corresponding to the post-cooling unit 12, a lifting and lowering device that vertically moves a cooling rod 22 and a fitting core 23 described later is provided. Above the upper base 10b, at a position corresponding to the taking-out unit 13, a lifting and lowering device is provided to move a taking-out core 31 up and down, an air introduction pipe 32, and a mold opening cam described later are provided.

In the upper base 10b and the transfer plate 14, through holes are formed at positions corresponding to the injection molding unit 11, the post-cooling unit 12, and the taking-out unit 13. As a result, the injection core mold (not illustrated), the cooling rod 22, the fitting core 23, the taking-out core 31, and the air introduction pipe 32 can approach or be inserted into the preform 1 or a neck mold 16. Further, the injection molding apparatus 10 supports the neck portion 2 of the preform 1 with a neck mold 16 (described later), and intermittently conveys the neck portion 2 to each molding portion (each step) of the injection molding unit 11, the post-cooling unit 12, and the taking-out unit 13 while maintaining a state where the neck portion 2 is always upward.

The injection molding unit 11, the post-cooling unit 12, and the taking-out unit 13 are disposed above the machine bed 10a or the lower base 10c. The injection molding unit 11, the post-cooling unit 12, and the taking-out unit 13 are disposed at positions rotated by a predetermined angle (for example, 120 degrees) with respect to the rotation center of the transfer plate 14 with respect to the machine bed 10a or the lower base 10c.

### Transfer Plate 14

The transfer plate 14 is composed of a single disk-shaped flat plate member or a plurality of substantially fan-shaped flat plate members divided for each forming station. On the lower surface side of the transfer plate 14, one or more neck mold fixing plates 17 each including a plurality of neck molds 16 for holding the neck portion 2 of the preform 1 are provided at predetermined angles. The neck mold 16 includes a pair of neck split molds 16a. The neck mold fixing plate 17 includes a pair of separable dividing plates 17a. The neck split molds 16a are each fixed to the dividing plate 17a, and open and close in the horizontal direction as the dividing plates 17a separate and come into contact.

The transfer plate 14 is moved in a rotation direction by a conveyance mechanism (not illustrated) including a rotation mechanism (the transfer plate 14 is rotated with respect to a central axis (rotation axis) of the transfer plate 14), and the preform 1 in which the neck portion 2 is held by the neck mold 16 (or the neck mold fixing plate 17) is conveyed to the injection molding unit 11, the post-cooling unit 12, and the taking-out unit 13 in this order. The conveyance mechanism further includes a lifting and lowering mechanism (vertical mold opening/closing mechanism), performs an operation of lifting and lowering the transfer plate 14 (or the upper base 10b supporting the transfer plate 14) and the injection core mold movable platen 10d, and also performs an operation related to mold closing and mold opening (releasing) in the injection molding unit 11.

### Injection Molding Unit 11

The injection molding unit 11 includes an injection cavity mold 11a having a plurality of cavities and an injection core mold fixing plate 11b having a plurality of injection core molds (not illustrated), and manufactures the preform 1 by injection molding. An injection device 15 that supplies a raw material (resin material) of the preform 1 is connected to the injection molding unit 11.

In the injection molding unit 11, the injection cavity mold 11a, the injection core mold, and the neck mold 16 of the transfer plate 14 are closed to form a preform-shaped mold space. Then, by injecting the resin material from the injection device 15 into such a mold space, the preform 1 is manufactured by the injection molding unit 11.

The material of the preform 1 is a thermoplastic synthetic resin, and can be appropriately selected according to the use of the container. Specific examples of the material include PET (polyethylene terephthalate), PEN (polyethylene naphthalate), PCTA (polycyclohexanedimethylene terephthalate), Tritan (tritan: copolyester), PP (polypropylene), PE (polyethylene), PC (polycarbonate), PES (polyethersulfone), PPUS (polyphenylsulfone), PS (polystyrene), COP/COC (cyclic olefin-based polymer), PMMA (polymethyl methacrylate: acrylic), and PLA (polylactic acid).

When the molds of injection molding unit 11 is opened (step of removing the preform 1 from the injection cavity mold 11a and removing the injection core mold from the preform 1), the neck mold 16 of the transfer plate 14 is not released (mold opened), and the preform 1 is held and conveyed as it is. The number of preforms 1 simultaneously molded by the injection molding unit 11 (the number of N×M shown below) can be appropriately set. For example, when the number of rows (N) of the neck mold fixing plates 17 is 3 and the number (M) of the neck molds fixed to one neck mold fixing plate 17 is 16, the number of preforms 1 simultaneously molded by the injection molding unit 11 is 48.

### Post-Cooling Unit 12

The post-cooling unit 12 has a function of cooling the preform 1 with a high-temperature, which is conveyed from the injection molding unit 11.

FIG. 2 is a diagram illustrating a configuration example of the post-cooling unit 12 in FIG. 1. In FIG. 2, a portion indicated by a reference sign A in FIG. 1 is partially illustrated. The post-cooling unit 12 includes a cooling cavity mold (cooling pot) 21, a cooling rod 22, and a fitting core (first core mold) 23 as a mold unit for cooling the preform 1. The cooling cavity mold 21 is an example of the first mold. Further, the cooling rod 22, the fitting core 23, and a tip piece 25 to be described later are an example of the second mold. The number of the cooling spaces of the cooling cavity mold 21 (to be described later), the cooling rods 22, the tip pieces 25, and the fitting cores 23 is preferably the same as the number of the preforms 1 molded at a time by the injection molding unit 11.

The cooling cavity mold 21 is a mold having a cooling space (a space for accommodating the preform 1) having substantially the same shape as the preform 1 manufactured by the injection molding unit 11. The cooling cavity mold 21 accommodates the preform 1 in the inner accommodating space and contacts the outer surface of the preform 1. A flow path (not illustrated) through which a temperature adjustment medium (refrigerant) flows is formed inside the cooling cavity mold 21. Therefore, the temperature of the cooling cavity mold 21 is maintained at a predetermined temperature by the temperature adjustment medium.

The temperature of the temperature adjustment medium of the cooling cavity mold 21 is not particularly limited, but can be appropriately selected within a range of 5° C. to 80° C., for example.

The cooling rod 22 and the fitting core 23 are both hollow cylindrical bodies, and the cooling rod 22 is disposed concentrically inside the fitting core 23. Further, the cooling rod 22 and the fitting core 23 are inserted inside the neck mold 16 and the preform 1.

In a state of being inserted into the neck mold 16, the tip of the fitting core 23 is in close contact with the inner periphery or the upper end surface of the neck portion 2 of the preform 1 to maintain airtightness with the preform 1. An opening 23a for exhausting air from the inside of the preform 1 is formed at the tip of the fitting core 23. A space between the cooling rod 22 and the fitting core 23 constitutes an exhaust flow path connected to an air exhaust portion (not illustrated).

The cooling rod 22 includes a cylindrical main body 24, and the tip piece 25 is attached to a tip of the main body 24. The cooling rod 22 is inserted inside the preform 1 to a position where the tip piece 25 abuts against the bottom 4 of the preform 1. The inside of the main body 24 of the cooling rod 22 constitutes a flow path for air supply that guides compressed air (air and gaseous refrigerant) from an air supply unit (not illustrated).

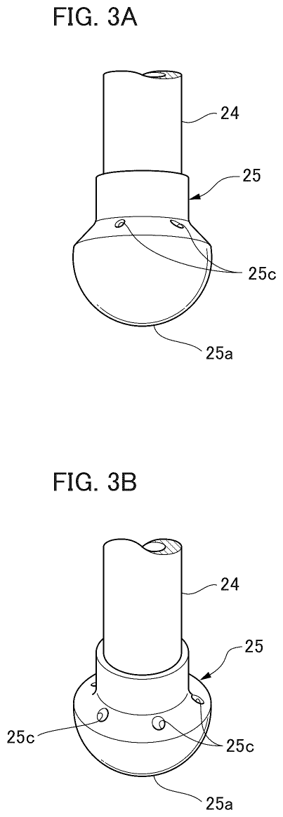

FIGS. 3A and 3B are perspective views illustrating a tip portion of the cooling rod 22 of FIG. 2. The tip piece 25 of the cooling rod 22 is a mold component having a curved mold surface 25a corresponding to the inner peripheral side shape of the bottom 4 of the preform 1 on the tip side. Although not particularly limited, the tip piece 25 is preferably formed of a material having high thermal conductivity such as aluminum or an aluminum alloy.

A mold surface 25a of the tip piece 25 has a function of receiving the bottom 4 of the preform 1, pressing the bottom 4 from the inside, and pressing the bottom 4 of the preform 1 against the inner surface of the cooling cavity mold 21. Consequently, when the cooling rod 22 is inserted into the preform 1, the bottom 4 of the preform 1 is sandwiched between the mold surface 25a of the tip piece 25 and the cooling cavity mold 21.

As illustrated in FIG. 2, an air flow path 25b communicating with the flow path for air supply of the main body 24 is formed in the tip piece 25. The air flow path 25b of the tip piece 25 branches in the vicinity of the tip of the tip piece 25 and is folded back toward the base end side (upper side in the figure, body portion side of preform) of the tip piece 25. The plurality of branched air flow paths 25b are arranged at equal intervals in the circumferential direction of the tip piece 25, and each communicate with an air ejection port 25c (opening) formed on the base end side of the mold surface 25a of the tip piece 25. Each air ejection port 25c is disposed so as to face a space between the preform 1 and the main body 24 of the cooling rod 22.

### Taking-Out Unit 13

The taking-out unit 13 is configured to release the neck portion 2 of the preform 1 cooled by the post-cooling unit 12 from the neck mold 16 and take-out the preform 1 to the outside of the injection molding apparatus 10. The taking-out unit 13 in the present embodiment has an air injection function for cooling and taking-out the preform 1.

FIG. 4 is a diagram illustrating a configuration example of the taking-out unit 13. In FIG. 4, a portion indicated by a reference sign B in FIG. 1 is partially illustrated. The taking-out unit 13 includes a taking-out core (second core mold) 31, an air introduction pipe 32, and a mold opening cam (not illustrated). The taking-out core 31 and the air introduction pipe 32 are an example of an auxiliary cooling unit.

The taking-out core 31 and the air introduction pipe 32 are both hollow cylindrical bodies, and the air introduction pipe 32 is concentrically disposed inside the taking-out core 31. Further, the air introduction pipe 32 and the taking-out core 31 are inserted into the neck mold 16 and the inside of the preform 1.

In a state of being inserted into the neck mold 16, the tip of the taking-out core 31 is in close contact with the inner periphery or the upper end surface of the neck portion 2 of the preform 1 to maintain airtightness with the preform 1. A ring-shaped airtight member 31b that abuts on the upper end surface of the neck portion 2 in an airtight manner is provided at the tip of the taking-out core 31. The airtight member 31b may be omitted. An opening 31a for exhausting air from the inside of the preform 1 is formed at the tip of the taking-out core 31. A space between the air introduction pipe 32 and the taking-out core 31 constitutes an exhaust flow path connected to an air exhaust unit (not illustrated).

The inside of the air introduction pipe 32 constitutes a flow path for introducing compressed air (air and gaseous refrigerant) from an air supply unit (not illustrated). An opening 32a for introducing air into the inside of the preform 1 is formed at the tip of the air introduction pipe 32. The tip of the air introduction pipe 32 is inserted to the vicinity of the bottom 4 of the preform 1.

Further, two sets of mold opening cams (not illustrated) having a wedge-like tip operate independently of the taking-out core 31 and the air introduction pipe 32, and separate the pair of neck split molds 16a in the closed state in a direction intersecting the axial direction of the preform 1. For example, the mold opening cam is inserted into a cam groove (not illustrated) located at both ends of the pair of dividing plates 17a in the mold-closed state, or abuts on a cam follower (not illustrated) provided on the dividing plate 17a instead of the cam groove. As a result, the neck mold 16 can be opened. Note that the neck mold 16 is normally maintained in a closed state by being biased by a spring incorporated in the pair of dividing plates 17a (or the neck mold fixing plate 17). The number of the taking-out cores 31 and the number of the air introduction pipes 32 are preferably the same as the number of the preforms 1 molded at a time by the injection molding unit 11.

### Description of Preform Manufacturing Method

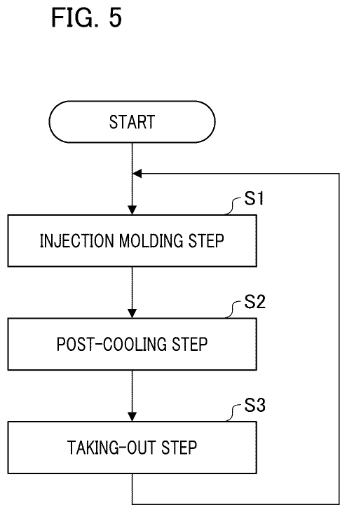

Next, a method for manufacturing the preform 1 by the injection molding apparatus 10 according to the present embodiment will be described. FIG. 5 is a flowchart illustrating steps of the method for manufacturing the preform 1.

### Step S1: Injection Molding Step

In step S1, in the injection molding unit 11, the injection core mold movable platen 10d and the transfer plate 14 (or the upper base 10b) are lowered, and the injection cavity mold, the injection core mold, and the neck mold 16 are closed. Then, the resin is injected from the injection device 15 into the preform-shaped mold space formed by closing the mold, thereby manufacturing the preform 1. Then, the injection mold (injection cavity mold and injection core mold) of the injection molding unit 11 is opened after the minimum cooling time provided after the completion of the injection (filling and pressure holding) of the resin material.

Although not particularly limited, from the viewpoint of manufacturing the preform 1 by a high-speed molding cycle, it is preferable to perform mold opening without providing a cooling time of the preform 1 in the injection mold after completion of injection (filling and pressure holding) of the resin material in step S1 (For example, the cooling time in the injection molding conditions set in the injection molding apparatus 10 is set to 0 second.). In the above case, since the preform 1 is not cooled in a state where there is no pressure holding in the injection mold, it is possible to suppress an event in which the preform 1 shrinks during the cooling time to cause sink marks.

On the other hand, in the case of performing the minimum cooling of the preform 1 in the injection mold, the time (cooling time) taken to cool the resin material in the mold after completion of injection of the resin material by the injection molding unit 11 is preferably ½ or less of a time (injection time (including pressure holding time)) taken to inject the resin material. The cooling time is more preferably ⅖ or less, still more preferably ¼ or less, and particularly preferably ⅕ or less with respect to the injection time of the resin material (for example, the cooling time in the injection molding conditions set in the injection molding apparatus 10 is set to any one of ½ or less, ⅖ or less, ¼ or less, and ⅕ or less of the injection time).

In step S1, when the injection core mold movable platen 10d and the transfer plate 14 (or the upper base 10b) are raised and the injection mold is opened, the preform 1 is released from the injection cavity mold and the injection core mold in a high temperature state in which the outer shape can be maintained. Next, the transfer plate 14 moves so as to rotate by a predetermined angle, and the preform 1 in the high temperature state held by the neck mold 16 is conveyed to the post-cooling unit 12.

### Step S2: Post-Cooling Step

Next, the preform 1 is cooled in the post-cooling unit 12. Since the high-temperature preform 1 is rapidly cooled in the post-cooling unit 12, this suppresses whitening (cloudiness) due to spherulite formation crystallization that may occur when the preform 1 is slowly cooled.

In the post-cooling unit 12, first, the preform 1 is accommodated in the accommodating space of the cooling cavity mold 21 by lowering of the transfer plate 14 (or the upper base 10b). Subsequently, the cooling rod 22 and the fitting core 23 are lowered from the first standby position where they do not interfere with the transfer plate 14 and inserted into the preform 1 accommodated in the cooling cavity mold 21. Here, the fitting core 23 is in close contact with the neck portion 2 of the preform 1, and airtightness is maintained between the preform 1 and the fitting core 23.

The cooling rod 22 is inserted into the preform 1. The mold surface 25a at the tip of the tip piece 25 presses the bottom 4 of the preform 1 downward, and presses the bottom 4 of the preform 1 against the cooling cavity mold 21.

The bottom 4 of the preform 1 in the post-cooling unit 12 is sandwiched between the tip piece 25 and the cooling cavity mold 21, and is in close contact with both molds. Therefore, in the post-cooling unit 12, the bottom 4 of the preform 1 is cooled by heat exchange between the tip piece 25 on the inner surface side and the cooling cavity mold 21 on the outer surface side.

In addition, since the tip piece 25 of the cooling rod 22 presses the bottom 4 of the preform 1 from the inside, irregular shrinkage deformation of the preform 1 is suppressed. Furthermore, the bottom 4 of the preform 1 is in close contact with the tip piece 25 and the cooling cavity mold 21, so that the bottom 4 of the preform 1 is held in a shape following the mold surface 25a of the tip piece 25 and the cooling cavity mold 21. As a result, the shape accuracy (dimensional accuracy) of the bottom 4 of the preform 1 can be improved.

Thereafter, cooling blow of the preform 1 is performed. In the cooling blow of the present embodiment, compressed air is introduced into the preform 1 from the air ejection port 25c via the flow path in the cooling rod 22 and the air flow path 25b of the tip piece 25, and the compressed air is exhausted from the opening 23a between the cooling rod 22 and the fitting core 23.

In the cooling blow, when compressed air is introduced into the preform 1 from the air ejection port 25c of the tip piece 25, the body portion 3 of the preform 1 is pressed against the cooling cavity mold 21. Therefore, in the post-cooling unit 12, the body portion 3 of the preform 1 is cooled on the inner surface side by contact with the compressed air and is cooled on the outer surface side by heat exchange with the cooling cavity mold 21. In addition, the body portion 3 of the preform 1 is held in a shape following the contour of the accommodating space of the cooling cavity mold 21.

In addition, since the air ejection port 25c of the tip piece 25 faces the space between the preform 1 and the main body 24 of the cooling rod 22, the air ejection port 25c is arranged not to face the inner surface of the preform 1. Therefore, the compressed air injected from the air ejection port 25c does not directly hit the bottom 4 or the body portion 3 of the preform 1. Therefore, it is possible to suppress the occurrence of deformation such as a local recess inside the preform 1 due to the pressure at the time of ejecting the compressed air. As described above, the shape accuracy of the bottom 4 and the body portion 3 of the preform 1 can be improved.

In the present embodiment, since the compressed air flows through the air flow path 25b of the tip piece 25, it is easy to cool the tip piece 25 that receives the heat of the bottom 4 of the preform 1. Therefore, even when the preform 1 is manufactured by a high-speed molding cycle, it is possible to suppress an increase in the temperature of the tip piece 25, and for example, defects such as sticking of the preform 1 to the tip piece 25 hardly occur.

When the cooling of the preform 1 in the post-cooling unit 12 is completed, the cooling rod 22 and the fitting core 23 are raised and separated from the preform 1, and then the transfer plate 14 (or the upper base 10b) is raised and the preform 1 is released from the cooling cavity mold 21. After the cooling rod 22 and the fitting core 23 reach the first standby position, next, the transfer plate 14 moves so as to rotate by a predetermined angle, and the preform 1 held by the neck mold 16 is conveyed to the taking-out unit 13.

### Step S3: taking-out Step

In the taking-out unit 13, after the transfer plate 14 (or the upper base 10b) is lowered, the taking-out core 31 and the air introduction pipe 32 are lowered from the second standby position where they do not interfere with the transfer plate 14, and are inserted into the preform 1 held by the neck mold 16. The taking-out core 31 is in close contact with the neck portion 2 of the preform 1, and airtightness is maintained between the preform 1 and the taking-out core 31. Thereafter, the compressed air is introduced into the preform 1 from the opening 32a of the air introduction pipe 32, and the inside of the preform 1 is supplementarily cooled. Although not particularly limited, the injection time and the injection pressure of the compressed air in the auxiliary cooling of the taking-out unit 13 may be set to be lower than those of the post-cooling unit 12.

By performing the auxiliary cooling of the preform 1 by the taking-out unit 13, the temperature of the preform 1 can be brought closer to normal temperature, and deformation due to thermal shrinkage of the preform 1 after being taken-out and a decrease in dimensional accuracy can be more reliably suppressed. Although the compressed air flows from the air introduction pipe 32 toward the bottom 4 of the preform 1 in the taking-out unit 13, the shape of the bottom 4 of the preform 1 hardly changes even if the compressed air hits the preform 1 because the preform 1 has already been cooled in the post-cooling unit 12.

When the auxiliary cooling of the preform 1 in the taking-out unit 13 is completed, the neck mold 16 is opened by the mold opening cam as indicated by an arrow in FIG. 4. Thereafter, by injecting compressed air from the air introduction pipe 32, the preform 1 is guided in the vertical direction and separated from the neck mold 16, and the preform 1 is taken-out to the outside of the injection molding apparatus 10. Then, the taking-out core 31 and the air introduction pipe 32 rise to the second standby position.

Thus, one cycle in the method for manufacturing the preform 1 ends. Thereafter, the respective steps S1 to S3 are repeated by moving the transfer plate 14 by a predetermined angle. During operation of the injection molding apparatus 10, three sets of preforms 1 having a time difference of one step are manufactured in parallel.

In addition, due to the structure of the injection molding apparatus 10, the injection molding step, the post-cooling step, and the taking-out step have the same length of time. Similarly, the conveyance time between the steps is the same.

Hereinafter, operational effects of the present embodiment will be described.

The post-cooling unit 12 of the injection molding apparatus 10 of the present embodiment includes a cooling cavity mold 21 that accommodates the preform 1 inside and contacts with the outer surface of the preform, a cooling rod 22 that is inserted into the preform 1 and has an internal flow path for compressed air, and a tip piece 25 attached to the tip side of the cooling rod 22. The tip piece 25 has a shape corresponds to the bottom of the preform 1 and includes a mold surface 25a that receives the bottom 4 and an air ejection port 25c that is formed on the base end side of the mold surface 25a and communicates with the flow path of the compressed air. The post-cooling unit 12 cools the bottom 4 in a state where the bottom 4 of the preform 1 is pressed against the cooling cavity mold 21 by the mold surface 25a of the tip piece 25, and cools the body portion 3 in a state where the body portion 3 of the preform 1 is pressed against the cooling cavity mold 21 by the compressed air passing through the air ejection port 25c.

In the present embodiment, the bottom 4 of the preform 1 is cooled by heat exchange between the tip piece 25 on the inner surface side and the cooling cavity mold 21 on the outer surface side. Further, by pressing the body portion 3 of the preform 1 against the cooling cavity mold 21 with the compressed air passing through the air ejection port 25c, the inner surface side of the body portion 3 of the preform 1 is cooled by contact with the compressed air, and the outer surface side is cooled by heat exchange with the cooling cavity mold 21. Therefore, the preform 1 released from the injection molding unit 11 at a high temperature can be efficiently cooled in a short time, and a decrease in dimensional accuracy of the preform 1 due to thermal shrinkage can be suppressed.

In the present embodiment, since the tip piece 25 presses the bottom 4 of the preform 1, irregular shrinkage deformation of the preform 1 released at a high temperature is suppressed. In addition, the shape of the bottom 4 of the preform 1 can be held by pressing the tip piece 25 against the mold surface 25a and the cooling cavity mold 21 during cooling. Furthermore, the body portion 3 is cooled in a state where the body portion 3 of the preform 1 is pressed against the cooling cavity mold 21 by the compressed air passing through the air ejection port 25c, whereby the body portion 3 can be held in a shape following the cooling cavity mold 21. Therefore, since the preform 1 that is easily released from the injection molding unit 11 at a high temperature and is easily deformed is held in a desired shape at the time of cooling, dimensional accuracy of the shape of the preform 1 can be improved.

Further, in the present embodiment, by performing auxiliary cooling of the preform 1 by the taking-out unit 13, it is possible to more reliably suppress deformation and deterioration in dimensional accuracy due to thermal shrinkage of the preform 1 after being taken-out.

In addition, by cooling the preform 1 in the post-cooling unit 12, the preform 1 can be released even in a high temperature state in the injection molding unit 11, and the cooling time of the preform 1 in the injection molding unit 11 can be significantly shortened. As a result, according to the present embodiment, since the molding of the next preform 1 can be started early, the molding cycle time of the preform 1 can be shortened.

In addition, the injection molding apparatus 10 supports the neck portion 2 of the preform 1 with the neck mold 16 from molding to taking-out, and maintains a state in which the neck portion 2 is always upward and the body portion 3 is always in the vertical direction. That is, the preform 1 is not molded horizontally by the injection molding unit 11, and the preform 1 is not released from the neck mold 16 also at the time of conveyance and transfer of the preform 1.

Here, the preform molded under the condition of a short cooling time and released from the injection mold is soft except for the neck portion 2, and the body portion 3 and the bottom 4 are easily deformed. For example, in a case where the preform is injection molded horizontally, the body portion 3 and the bottom 4 hang down and bend by their own weight at the time of releasing the preform from the injection mold, and the preform 1 according to the standard or specification cannot be molded. In addition, when the preform 1 is conveyed and transferred between the injection molding unit 11 and the post-cooling unit 12 while being separated from the neck mold 16, the body portion 3 and the bottom 4 are deformed due to vibration or the like, so that the preform 1 cannot be accommodated in the cooling cavity mold 21 of the post-cooling unit 12 with high positional accuracy and cannot be appropriately cooled. Then, a bent mark or a deformed mark remains in the preform 1 after cooling.

According to the injection molding apparatus 10 of the present embodiment, deformation of the preform 1 at the time of release from the injection mold or at the time of transfer can be suppressed, so that the above-described problem does not occur even if the molding cycle time is shortened.

The present invention is not limited to the above embodiments, and various improvements and design changes may be made without departing from the gist of the present invention.

In the post-cooling unit 12 of the above embodiment, an example has been described in which the compressed air is introduced into the preform 1 from the air ejection port 25c of the tip piece 25, and the compressed air is exhausted from the opening 23a of the fitting core 23. However, compressed air may be introduced into the preform 1 from the opening 23a of the fitting core 23, and the compressed air may be exhausted from a side of the tip piece 25.

In the above embodiment, an example has been described in which the preform 1 is supplementarily cooled by injecting the compressed air in the taking-out unit 13. However, the taking-out unit 13 may not be provided with a configuration for injecting the compressed air, and the taking-out unit 13 may not perform auxiliary cooling of the preform 1.

In the above embodiment, an example has been described in which the preform 1 is supplementarily cooled by injection of the compressed air in the taking-out unit 13, and then the neck mold 16 is opened to separate the preform. However, the auxiliary cooling and the taking-out of the preform 1 may be performed simultaneously by injecting the compressed air after the neck mold 16 is opened by the taking-out unit 13.

In addition, the embodiments disclosed herein are to be considered in all respects as illustrative and not restrictive. The scope of the present invention is indicated not by the above description but by the claims, and it is intended that meanings equivalent to the claims and all modifications within the scope are included.

1. A preform manufacturing apparatus comprising:
an injection molding unit configured to inject and mold a bottomed cylindrical resin preform using an injection mold;
a post-cooling unit configured to cool the preform manufactured in the injection molding unit; and
a taking-out unit configured to take-out the preform cooled in the post-cooling unit to the outside of the apparatus, wherein
the post-cooling unit includes:
a first mold which accommodates the preform inside and which contacts the outer surface of the preform; and
a second mold which is inserted into the preform and which is provided with at least a cooling rod having an internal flow path for compressed air and a tip piece which is attached to a tip side of the cooling rod,
the tip piece has a shape corresponding to a bottom of the preform and includes a mold surface that receives the bottom, and an opening formed on a base end side of the mold surface and communicating with the flow path of the compressed air, and
the post-cooling unit cools the bottom of the preform while pressing the bottom of the preform against the first mold with the mold surface of the tip piece, and cools a body portion of the preform while pressing the body portion against the first mold with the compressed air passing through the opening.

2. The preform manufacturing apparatus according to claim 1, wherein
the second mold further includes a cylindrical core mold that abuts against a neck portion of the preform.

3. The preform manufacturing apparatus according to claim 1, wherein
the compressed air in the post-cooling unit is introduced from the opening toward the body portion of the preform.

4. The preform manufacturing apparatus according to claim 1, wherein
the taking-out unit has an auxiliary cooling unit configured to introduce compressed air into the preform.

5. The preform manufacturing apparatus according to claim 4, wherein
the auxiliary cooling unit introduces compressed air into the preform before the preform is released from a neck mold that holds the preform.

6. The preform manufacturing apparatus according to claim 1, wherein
in the injection molding unit, the injection mold is opened after filling with a resin material and pressure holding are completed, and the preform after filling and pressure holding are completed is taken-out without being cooled within the injection mold.

7. The preform manufacturing apparatus according to claim 1, wherein
in the injection molding unit, a time taken to cool a resin material in the injection mold after injection of the resin material is completed is ½ or less of a time taken to inject the resin material into the injection mold.

8. A preform manufacturing method comprising:
injecting and forming a bottomed cylindrical resin preform using an injection mold as injection molding;
cooling the preform manufactured in the injection molding as post-cooling; and
taking-out the preform cooled in the post-cooling to the outside of the apparatus, wherein
in the post-cooling,
a first mold which accommodates the preform inside and which contacts the outer surface of the preform; and
a second mold which is inserted into the preform and which is provided with at least a cooling rod having an internal flow path for compressed air and a tip piece which is attached to a tip side of the cooling rod are used,
the tip piece has a shape corresponding to a bottom of the preform and includes a mold surface that receives the bottom, and an opening formed on a base end side of the mold surface and communicating with the flow path of the compressed air, and
in the post-cooling, the bottom of the preform is cooled while pressing the bottom of the preform against the first mold with the mold surface of the tip piece, and a body portion of the preform is cooled while pressing the body portion against the first mold with the compressed air passing through the opening.

9. A cooling mold used in a post-cooling unit of a preform manufacturing apparatus, the apparatus including an injection molding unit configured to inject and mold a bottomed cylindrical resin preform using an injection mold; the post-cooling unit configured to cool the preform manufactured in the injection molding unit; and a taking-out unit configured to take-out out the preform cooled in the post-cooling unit to the outside of the apparatus, the cooling mold comprising:
a first mold which accommodates the preform inside and which contacts the outer surface of the preform; and
a second mold which is inserted into the preform and which is provided with at least a cooling rod having an internal flow path for compressed air and a tip piece which is attached to a tip side of the cooling rod, wherein
the tip piece has a shape corresponding to a bottom of the preform and includes a mold surface that receives the bottom, and an opening formed on a base end side of the mold surface and communicating with the flow path of the compressed air.
